(19) United States
(12) Patent Application Publication
(10) Pub. No.: US 2018/0179898 A1
(43) Pub. Date: Jun. 28, 2018

(54) NOZZLE SECTOR FOR A TURBINE ENGINE WITH DIFFERENTIALLY COOLED BLADES

(71) Applicant: SAFRAN AIRCRAFT ENGINES, Paris (FR)

(72) Inventors: Olivier Jean Daniel BAUMAS, Vert Saint Denis (FR); Anne-Marie ARRAITZ, Nandy (FR); Anthony Pierre BEGUIN, Paris (FR); Pragash DOUGLAS, Paris (FR)

(73) Assignee: SAFRAN AIRCRAFT ENGINES, Paris (FR)

(21) Appl. No.: 15/759,316

(22) PCT Filed: Sep. 15, 2016
(86) PCT No.: PCT/FR2016/052338

§ 371 Date: Mar. 12, 2018

(30) Foreign Application Priority Data
Sep. 17, 2015 (FR) 15 58759

(51) Int. Cl. F01D 5/18; F01D 9/04

(52) U.S. Cl. CPC F01D 5/186; F05D 2240/128; F05D 2260/202; F01D 9/041

(57) ABSTRACT

A nozzle sector for a turbine engine. The nozzle sector includes a radially outer platform, a radially inner platform, a first end blade, a second end blade and at least one first central blade between the end blades in a circumferential direction of the platforms. The blades extend radially between the platforms in the direction of the span of said blades. The sector includes means for cooling the blades, configured to cool each of the blades by circulating cooling air over same. The cooling means are configured to cool the one or more central blades more than at least one of the end blades.

### TECHNICAL FIELD

The invention relates to the cooling of nozzle sectors for a turbine of a turbomachine. It is applicable to any type of terrestrial or aeronautical turbomachines, and in particular to aircraft turbomachines such as turbojet engines and turboprop engines.

### STATE OF PRIOR ART

Turbine nozzles of aircraft turbomachine are conventionally divided in sectors along their circumferential direction. A nozzle sector comprises two platforms and a plurality of vanes radially extending between the platforms. These vanes are spaced apart from each other along the circumferential direction of the sector. Cooling air circulates inside the vanes to cool them identically.

The nozzle sector vanes are subjected to significant mechanical loads which can lead to the destruction of these vanes. Thus, there is a need for reducing the mechanical loads of the vanes.

### DISCLOSURE OF THE INVENTION

The invention aims at solving at least partially the problem met in the solutions of prior art.

In this regard, one object of the invention is a nozzle sector for a turbine of a turbomachine.

The nozzle sector comprises a radially outer platform for supporting vanes and a radially inner platform for supporting vanes. The sector also includes a first end vane, a second end vane and at least one first central vane between the end vanes along a circumferential direction of the platforms, the vanes radially extending between the platforms along a span direction of these vanes.

The nozzle sector also comprises means for cooling the vanes which are configured to cool each of the vanes by circulating cooling air therein.

According to the invention, the cooling means are configured to differentially cool the or each central vane at least with respect to the first end vane.

The cooling means of at least one of the vanes comprise cooling holes, the cooling holes passing through an external wall of the vane and/or a cooling jacket inside the vane.

First cooling holes passes through a first of the end vanes, second cooling holes passing through the first central vane, the total area of the second cooling holes being higher than that of the first cooling holes.

By differentially cooling the vanes with respect to each other, the cooling means enable the vanes to be better adapted to differential thermal expansions within the platforms or between the platforms which are more rigid. As a result, there is a reduction in mechanical stresses exerted on these vanes, in particular at their respective blades.

The invention can optionally include one or more of the following characteristics combined to each other or not.

Advantageously, the cooling means are configured to cool the first end vane less than the central vane.

According to a particular embodiment, the cooling means are configured to cool the first end vane as much as the second end vane.

According to an advantageous embodiment, the sector comprises at least four vanes including at least one second central vane between the end vanes along a circumferential direction of the platforms, the cooling means being configured to cool the first central vane as much as the second central vane.

According to another advantageous embodiment, the cooling means comprise identical cooling air feeding means for each of the vanes of the nozzle sector.

The invention is also concerned with a turbine for a turbomachine comprising at least one nozzle sector as defined above.

The turbine is preferably a low pressure turbine for a turbomachine.

The nozzle sector as defined above is preferably part of the first turbine stage which is located most upstream of the turbine.

The invention also deals with a turbomachine comprising a turbine as defined above. The turbomachine is in particular an aircraft turbomachine.

Finally, the invention relates to a method for cooling a nozzle sector for a turbomachine, comprising a step of differentially cooling a first central vane with respect to a first end vane.

According to an advantageous embodiment, the differential cooling step is made by cooling the first end vane less than the first central vane.

### BRIEF DESCRIPTION OF THE DRAWINGS

The present invention will be better understood upon reading the description of exemplary embodiments, given by way of purely indicating and in no way limiting purposes, making reference to the appended drawings in which:

FIG. 1 is a partial schematic representation of a turbine for a turbomachine, according to a first embodiment of the invention;

FIG. 2 is a partial elevation schematic representation viewed from downstream of a turbine nozzle sector, according to the first embodiment;

FIG. 3 is a side view along the arrow A of the nozzle sector according to the first embodiment;

FIG. 4 is a cross-section partial schematic representation along line IV-IV of a vane of the nozzle sector;

FIG. 5 is a side view of a cooling jacket located inside one of the nozzle vanes according to the first embodiment; and

FIG. 6 illustrates the implementation of a method for differentially cooling the vanes of the nozzle sector according to the first embodiment.

### DETAILED DISCLOSURE OF PARTICULAR EMBODIMENTS

Identical, similar or equivalent parts of the different figures bear the same reference numerals so as to facilitate switching from one Fig. to the other.

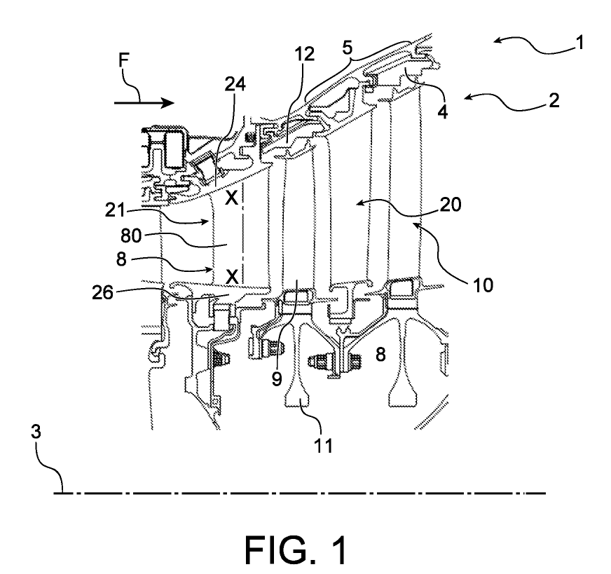

FIG. 1 represents a low pressure turbine 2 for an aircraft turbomachine. The low pressure turbine 2 is annular about a longitudinal axis 3 of a turbomachine. This axis is also the axis of rotation of the turbomachine 1.

The direction of the longitudinal axis 3 of a turbomachine 1, also called the axial direction, is that of the main normal flow direction F of gases within the turbomachine 1. Throughout the description, it is noted that the terms upstream and downstream are to be considered with respect to this gas flow direction F (from upstream to downstream).

A radial direction of the turbomachine is a direction perpendicular to the longitudinal axis 3 of the turbomachine 1 outwardly of the turbomachine. A circumferential direction Z-Z is an ortho radial direction, about the longitudinal axis 3. Further, unless otherwise indicated, the adjectives and adverbs axial, radial, circumferential, axially and radially are used in reference to the abovementioned axial, radial and circumferential directions. The adjectives inner and outer on the one hand, lower and upper on the other hand are also defined depending on their distance from the longitudinal axis 3.

The low pressure turbine 2 includes a plurality of stages 4 housed in a turbine outer casing 5. Each stage 4 includes a wheel 10 and a nozzle 20.

The wheel 10 is rotatably movable about the longitudinal axis 3 inside a sectorised ring 12 which is fastened to the casing 5. It includes an annular row of movable vanes 9 and a disk 11 in which the movable vanes 9 are mechanically engaged by radially extending from the disk 11.

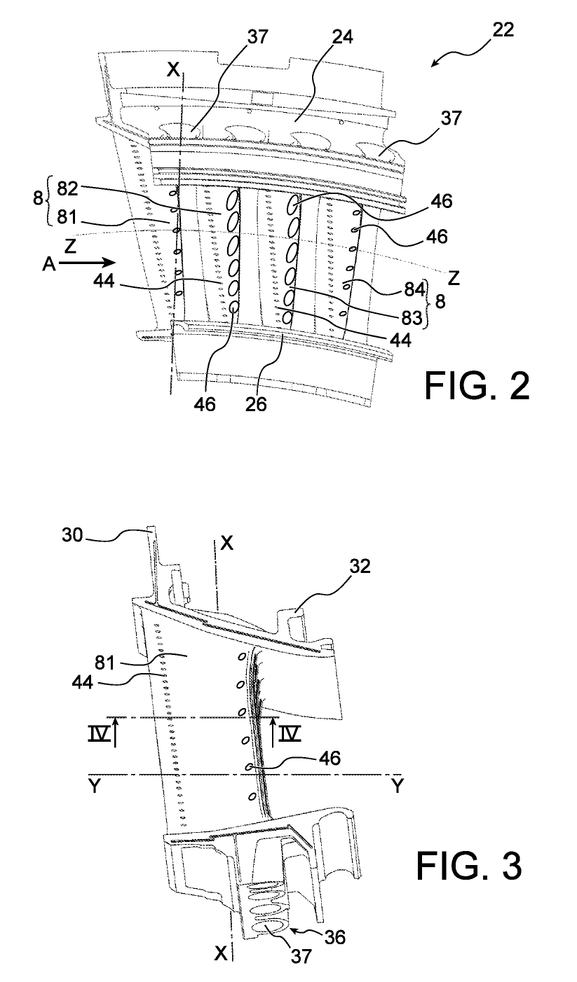

The nozzle 20 is part of the turbomachine stator. It is divided in annular sectors 22 (FIG. 2) each comprising fixed vanes 8 spaced from each other and which are axially sandwiched between the annular rows of movable vanes 9. The fixed vanes 8 each comprise an upper platform 24, also called a radially outer platform 24, a lower platform 26, also called a radially inner platform 26, and a blade 80 radially extending between the upper platform 24 and the lower platform 26. These nozzle vanes 8 are fastened to the casing 5 via their upper platform 24 by an upstream fastening rim 32 and a downstream fastening rim 30 which are represented in FIG. 3.

The fixed vanes 8 of the nozzle 20 are subjected to high mechanical loads, generated in particular by differential expansions within these vanes 8. These differential expansions are enhanced at the first nozzle stage 21, because of particularly high temperature gradients prevailing therein. This first nozzle stage 21 is part of the stage located most upstream in the low pressure turbine 2.

In order to reduce the mechanical loads of the fixed vanes 8, they are differentially cooled within nozzle sectors 22, so as to better follow the mechanical deformations of the platforms 24, 26 which are more rigid. Such a sector 22 is particularly adapted to the first nozzle stage 21.

In reference to FIG. 2, the nozzle sector 22 comprises four fixed vanes 81, 82, 83, 84 which radially extend between the upper platform 24 and the lower platform 26. These vanes 81, 82, 83, 84 are spaced apart from each other along the circumferential direction Z-Z.

These vanes comprise a first end vane 81, a second end vane 84, as well as a first central vane 82 and a second central vane 83. The central vanes 82, 83 are located between the end vanes 81, 84 along the circumferential direction Z-Z.

In reference to FIG. 2 and FIG. 3 together, the fixed vanes 8 of the sector 22 are fed with cooling air by cooling ducts 37. The ducts 37 pass entirely through them along their span direction X-X which substantially corresponds to a radial direction.

The ducts 37 open onto the upper platform 24 on the one hand and at the foot 36 of the nozzle sector 22 on the other hand. They are identical for each of the vanes 81, 82, 83, 84 of the nozzle sector 22 for which they form cooling air feeding means.

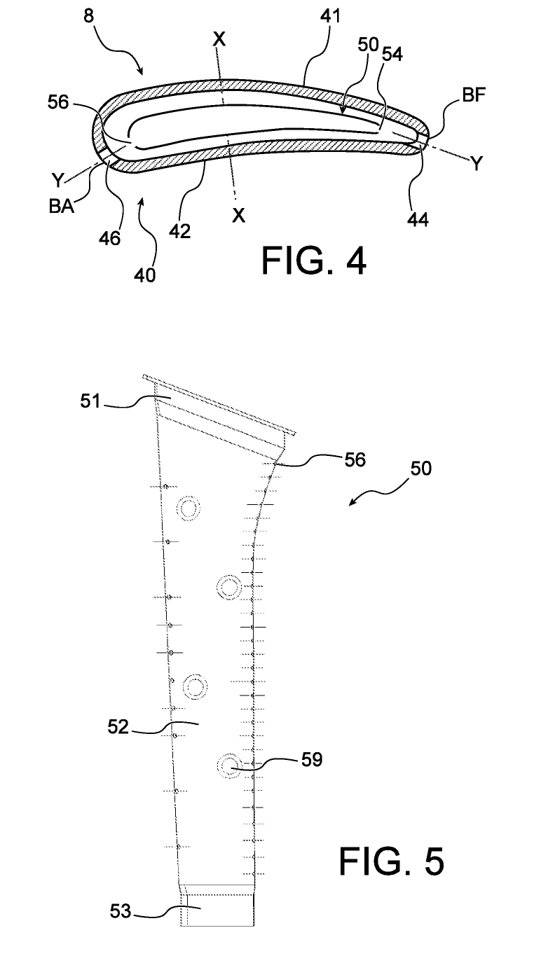

Each of the vanes 81, 82, 83, 84 of the nozzle sector includes cooling holes 44, 46 to expel part of the air which circulated therein into a pathway of the turbomachine 1. Some cooling holes 46 pass through the external wall 40 of the vane in proximity of its leading edge BA, visible in FIG. 4. Other cooling holes 44 pass through the external wall 40 of the vane in proximity of its trailing edge BF, visible in FIG. 4. These cooling holes are substantially aligned and spaced apart from each other along the span direction X-X.

The cooling holes 44, 46 of the first central vanes 82 have cross-sections which are substantially identical to that of the cooling holes 44, 46 of the second central vane 83. On the other hand, the cooling holes 44, 46 of the central vanes 82, 83 have a higher cross-section than that of the cooling holes 44, 46 of the end vanes 81, 84, for example a cross-section 10% to 50% higher and preferably 10% to 15% higher. The central vanes 82, 83 are thus more cooled than the end vanes 81, 84. The end vanes 81, 84 thereby are further expanded under the effect of hot gases passing through the pathway of the turbomachine, to better accompany mechanical deformations of the platforms 24, 26. As a result, there is a decrease in the mechanical stresses undergone by the vanes 81, 82, 83, 84 of the nozzle sector 22 which better adapt to the deformations of the platforms 24, 26.

In reference to FIG. 4, each of the blades 80 of the vanes 81, 82, 83, 84 comprises a top wall 41 and a bottom wall 42 each connecting the leading edge BA to the trailing edge BF which is located downstream of the leading edge BA. The bottom 41 and top 42 walls commonly define an external wall 40 of the vane 8.

The bottom 41 and top 42 walls are spaced sideways from each other along the circumferential direction Z-Z and define a median line therebetween, the skeleton line Y-Y, which extends substantially along the axial direction.

The upstream cooling holes 46 in proximity of the leading edge BA and the downstream cooling holes 44 in proximity of the trailing edge BF pass through the external wall 40 of the vane.

Inside the external wall 40, the vane 8 comprises a jacket 50 which forms the part of the cooling duct 47 inside the blade 80.

In reference to FIG. 4 and FIG. 5 together, the cooling jacket comprises a body 52 which extends along the span direction X-X from an upper rim 51 to a lower edge 53.

The body 52 is centred sideways between the top 41 and bottom 42 walls by projecting parts 59.

Downstream cooling holes 54 which feed the downstream cooling holes 44 of the external wall 40 of the vane from the duct 37 pass through the body 52. The downstream cooling holes 54 are spaced from each other by being substantially aligned along the span direction X-X.

Upstream cooling holes 56 which feed the upstream cooling holes 46 of the external wall 40 of the vane from the duct 37 pass through the body 52. The upstream cooling holes 56 are spaced apart from each other by being substantially aligned along the span direction X-X.

The cooling holes 54, 56 of the first central vane 82 have cross-sections substantially identical to that of the cooling holes 54, 56 of the second central vane 83.

Furthermore, the cooling holes 54, 56 of the central vanes 82, 83 have a higher cross-section than that of the cooling holes 54, 56 of the end vanes 81, 84. The central vanes 82, 83 are thus more cooled than the end vanes 81, 84.

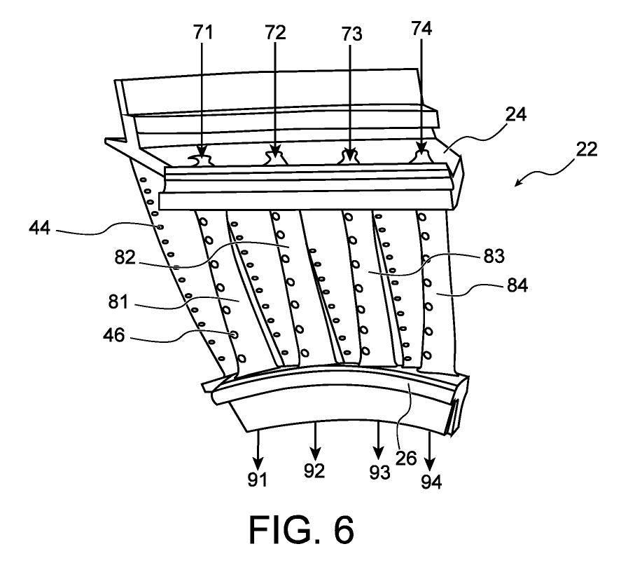

The method for cooling the nozzle sector 22 is described in further detail in reference to FIG. 6.

The cooling method comprises a step of introducing cooling air inside each of the vanes 81, 82, 83, 84 according to distinct streams 71, 72, 73, 74.

This air is then expelled off each of the vanes 81, 82, 83, 84 through the cooling holes 44, 46 of the vane and through the duct 37 at the foot 36.

More cooling air flows in the central vanes 82, 83 than in the end vanes 81, 84, because of the total cross-section difference of the cooling holes of these vanes.

More precisely, the end vanes 81, 84 are comparatively less cooled in a nozzle sector 22 according to the invention than in some known nozzle sectors 22, which is partially contrary to the principle of cooling as much as possible the nozzle vanes 8 to promote their mechanical strength.

However, the differential cooling of the vanes 81, 82, 83, 84 enables mechanical deformations of the platforms 24, 26 to be better accompanied, which increases the overall mechanical strength of the vanes 8 beyond the mechanical strength loss caused by the higher temperature of the end vanes 81, 84.

Of course, various modifications can be provided by those skilled in the art to the invention just described without departing from the scope of disclosure of the invention.

The nozzle sector 22 can include five or more vanes 8.

It is possible to further cool one of the central vanes 82, 83 with respect to the other of these central vanes 82, 83.

If the nozzle sector 22 includes three or more central vanes, it is even preferable to cool more those which are closer to the median line of the nozzle along the circumferential direction Z-Z with respect to the other central vanes.

Further, it is contemplatable to cool more one of the end vanes 81, 84 with respect to the other of these end vanes 81, 84.

1-8. (canceled)

9. A nozzle sector for a turbine of a turbomachine, comprising:
a radially outer platform for supporting vanes,
a radially inner platform for supporting vanes,
a first end vane, a second end vane and at least one first central vane between the end vanes along a circumferential direction of the platforms, wherein the vanes each radially extend between the platforms along a span direction of the vane,
cooling means for cooling the vanes, configured to cool each of the vanes by circulating cooling air therein, wherein the cooling means are configured to differentially cool the or each central vane at least with respect to the first end vane,
the cooling means comprising cooling holes, wherein the cooling holes pass through an external wall of at least one of the vanes and/or wherein the cooling holes pass through a cooling jacket inside the vane,
wherein the cooling means comprise first cooling holes passing through the external wall of the first of the end vanes, wherein the cooling means comprise second cooling holes passing through the external wall of the first central vane, wherein the total area of the second cooling holes is higher than that of the first cooling holes.

10. The nozzle sector according to claim 9, wherein the cooling means are configured to cool the first end vane less than the central vane.

11. The nozzle sector according to claim 9, wherein the cooling means are configured to cool the first end vane as much as the second end vane.

12. The nozzle sector according to claim 9, comprising at least four vanes including at least one second central vane between the end vanes along a circumferential direction of the platforms, wherein the cooling means are configured to cool the first central vane as much as the second central vane.

13. The nozzle sector according to claim 9, wherein the cooling means comprise cooling air feeding means for feeding each of the vanes of the nozzle sector with air, wherein the cooling air feeding means are identical.

14. A turbine for a turbomachine, comprising at least one nozzle sector according to claim 9.

15. A turbine for a turbomachine according to claim 14, wherein the turbine is a low pressure turbine.

16. A turbomachine comprising a turbine according to claim 15.

17. A method for cooling a nozzle sector for a turbomachine, comprising a step of differentially cooling a first central vane with respect to a first end vane, by cooling the first end vane less than the central vane,
the step of differentially cooling being performed with cooling holes, wherein the cooling holes pass through an external wall of at least one of the vanes and/or wherein the cooling holes pass through a cooling jacket inside the vane,
wherein the cooling holes comprise first cooling holes passing through the external wall of the first of the end vanes, wherein the cooling holes comprise second cooling holes passing through the external wall of the first central vane, wherein the total area of the second cooling holes is higher than that of the first cooling holes.
